(19) United States
(12) Patent Application Publication
(10) Pub. No.: US 2019/0061747 A1
(43) Pub. Date: Feb. 28, 2019

(54) Method For Assisting A Driver Of A Motor Vehicle During A Turning Manoeuvre, Driver Assistance System And Motor Vehicle

(71) Applicant: SMR Patents S.à.r.l., Luxembourg (LU)

(72) Inventor: Romeo Wieczorek, Stuttgart (DE)

(21) Appl. No.: 16/114,965

(22) Filed: Aug. 28, 2018

(30) Foreign Application Priority Data
Aug. 29, 2017 (DE) 10 2017 119 834.2

(51) Int. Cl. B60W 30/095; B60W 30/09; B60W 50/14; G08G 1/16

(52) U.S. Cl. CPC B60W 30/095; B60W 30/09; B60W 50/14; G08G 1/166; B60W 10/18; B60W 2420/52; B60T 2201/022; B60R 2300/205; B60W 2420/42

(57) ABSTRACT

A method for assisting a driver of a motor vehicle during a turning maneuver includes detecting the driver's intention to make a turning maneuver, detecting at least one further road user and determining at least the speed of the at least one further road user, determining whether it is possible to make the turning maneuver safely as a function of at least the determined speed, and displaying information relating to the safety of the turning maneuver, which is superimposed on the direct view of the at least one further traffic user for the driver. A driver assistance system is used to carry out the method, and a motor vehicle includes a driver assistance system.

### CROSS-REFERENCE TO RELATED APPLICATIONS

This application claims the benefit of foreign priority to German Patent Application No. DE 10 2017 119 834.2, filed Aug. 29, 2017, which is herein incorporated by reference in its entirety for all purposes.

### BACKGROUND

### 1. Field of the Invention

The following description relates to a method for assisting a driver of a motor vehicle during a turning maneuver, a driver assistance system which is set up to carry out such a method, and a motor vehicle having such a driver assistance system.

### 2. Related Art

Driver assistance systems which help a driver to operate a motor vehicle safely are increasingly being used in modern motor vehicles. In this case, a distinction can be made between active systems which independently intervene in the driving of the motor vehicle, and passive systems which merely provide the driver with information.

There is a particularly high risk of accidents during turning maneuvers. In this case, left turning maneuvers, during which the right of way of a further road user has to be observed, are in particular accident-prone. Especially unexperienced or older road users frequently have problems estimating the speed of other road users and, thus, evaluating whether a turning maneuver can be safely carried out.

A driver assistance system by means of which gaps in the oncoming traffic can be identified during a left turning maneuver is described by DE 10 2006 040 331 A1. The system identifies sufficiently large gaps for a turning maneuver and indicates the turning possibility to the driver.

In order to detect the information provided by such a system, the driver must, however, look away from what is happening in the traffic so that he can view the system's recommendation which is displayed. The display is typically a monitor on the dashboard. This reduces the driver's attention in a traffic situation which is already critical and prone to accidents.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. In one aspect, a mounting assembly for an exterior attachment device which offers particularly good protection against theft of such external attachment devices is described.

In at least one example, a method for assisting a driver of a motor vehicle during a turning maneuver is described. For example, a driver is to be assisted during a turning maneuver in such a way that the amount of attention directed to traffic conditions and circumstances is not adversely affected.

In an aspect, a method for assisting a driver of a motor vehicle during a turning maneuver, such as during a left turning maneuver, includes detecting the driver's intention to make a turning maneuver, detecting at least one further road user and determining at least the speed of the at least one further road user, determining whether it is possible to make the turning maneuver safely as a function of at least the determined speed, and displaying information relating to the safety of the turning maneuver which is superimposed on the direct view of the at least one further road user for the driver.

By superimposing the information about the at least one further road user it can be ensured that the driver of the motor vehicle receives the necessary information without having to look away from what is happening in the traffic. In this case, the term “superimposing” does not necessarily mean that the other road user is concealed by the displayed information. A laterally offset arrangement of the displayed information is also possible.

Although a left turning maneuver in particular is discussed, this is to be considered simply as an example. The safety in terms of pedestrians crossing the road or cyclists can also be improved during right turns by means of the described method. Of course, the same applies to countries where vehicles drive on the left. In this situation, the indicated directions are to be transposed.

The information may be displayed on the windscreen because the line of the vision of the vehicle occupants is, as a general rule, directed at said windscreen anyway. This can take place, for example, by means of a head-up display. A head-up display can, in addition, extend—as a function of the line of the vision of the occupant—in parts through a window and in other parts through another component of the motor vehicle. In addition, the display can be provided by means of another projection instead of by a head-up display, for instance two-dimensionally or utilizing holographic technology, as well as by light-emitting diodes (inorganic and organic LEDs) or liquid crystals (LCD display).

Lighting and display means integrated in the (glass) body of the windscreen may also be used, such as so-called “see-through displays”. LCDs as well as inorganic or organic LEDs may be used. A device worn on the body by the occupant (for instance: goggles) may additionally or alternatively include the display where the device may be controlled by a data processing apparatus of the motor vehicle.

The displayed information may include an indication relating to a time frame during which the turning maneuver is determined to be safe. The time frame may be displayed by a countdown and/or a progress bar, e.g. by a numerical representation of a cuntdown. The term “numerical representation of a countdown” refers, for example, to symbols of any format, such as Arabic numerals, Roman numerals, letter countdowns or other symbol or number formats, the sequence of which can be used to represent a count down.

At least one advantage of certain described examples, among others, includes receiving more than merely “Yes/No” information. In this example, a driver can not only identify whether the turning maneuver is safe but also whether it can be carried out in a way which is convenient for his own driving style. This further protects the driver from making hasty decisions such as, for example, rapidly exploiting a small gap in the oncoming traffic.

In this example, the time frame can also be established, taking account of the driving habits or respectively the driving style of the driver of the motor vehicle. This can, for example, flow into the method in the form of a self-learning process, during which method the driver assistance system adapts the established time frame on the basis of saved empirical values regarding usual speeds and/or reaction times of the driver.

If a countdown and/or a progress bar is displayed, information which can be directly and easily detected and which can be perceived and understood without appreciably distracting the driver may be output.

The information relating to the safety of the turning maneuver may include optical highlighting, in particular by means of a frame and/or color coding.

The at least one further road user may be highlighted by a frame which is colored green during a safe turning maneuver and which is represented in red in the event of a risk. Precisely such a color scheme, which is usual in the field of road traffic, can convey the necessary information to the driver in a particularly simple and direct manner.

The at least one further road user and the speed and/or acceleration thereof may be detected by means of at least one sensor device, in particular in the form of a front view camera, a radar sensor and/or a laser, and/or by means of a vehicle-to-vehicle communication device.

The speed—or the acceleration—of the at least one further road user can be established by comparing successive individual measurements. The Doppler shift of a modulated radar or laser signal can be enlisted for measuring the speed. Such measurements may be advantageously carried out continuously so that the information regarding the safety of the turning maneuver can be updated in real time.

The intention to make a turning maneuver may be detected by detecting the operation of an indicator and/or driving into a turning lane, for example, using position information regarding the motor vehicle and/or on the basis of a signal of a front view camera, and/or a braking maneuver, and/or a steering wheel angle.

The identifying of the operation of an indicator may make it possible to identify the driver's wish to turn in a particularly simple and direct manner. Since one usually slows down, that is to say brakes when turning, a threshold or a range of braking which is typical of a turning maneuver can be defined. In addition, the size of the steering wheel angle can be detected and can be compared with stored thresholds, in order to determine whether a turning maneuver is intended. Other road behavior may also be evaluated.

At least one further variable which is characteristic of the traffic situation may be detected and taken into consideration during the determination of the display by displaying additional information. In this example, it is possible to identify the intention to make a turning maneuver if the driver inadvertently forgets to operate the indicator. In this way, the safety of the turning maneuver can also be ensured.

The further variable may be determined as a function of traffic signs, rights of way, street alignments and/or weather conditions.

The information of a satellite navigation system such as, for example, the GPS (Global Positioning System) or the Galileo system, or of an inertial navigation system may be utilized as the position information.

The information may only displayed if it is determined that the at least one further road user has the right of way.

In another aspect, a method includes further steps of determining whether the at least one further road user has the right of way, where the information is only displayed if it is determined that the at least one further road user has the right of way.

As a result, it can be avoided that the driver receives unnecessary information which he does not need and which would only constitute a distraction. This can also be established on the basis of a navigation system from the combination of the geographical position indication of the motor vehicle and stored map data. Here, the detection of traffic signs and road markings can additionally be utilized.

In yet another aspect, a driver assistance system carries out the described method.

In a further aspect, a motor vehicle includes a driver assistance system.

The information may be displayed in the region of a windscreen and/or via a head-up display.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the invention is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the invention.

FIG. 1 is a diagram illustrating an example of a schematic representation of a traffic situation with a left turning motor vehicle and an oncoming vehicle.

FIG. 2 is a diagram illustrating an example of a schematic representation of the display of a driver assistance system on a windscreen of a motor vehicle.

### DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The term “rearview” is here defined as a view of the surrounding area, which is not in the field of view of the driver, i.e. the directions opposing, left, right, below and above of the viewing direction, but can also include the view in the direction of the viewing direction of the driver and/or any combinations of the directions.

The term “driver” and “driver of the vehicle” relates here to the person controlling the main parameters of the vehicle, such as for example direction, speed and/or altitude, e.g. normally the person located in the location specified for the controlling person, for example a seat, but can also relate to any other person or entity within or outside of the vehicle.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

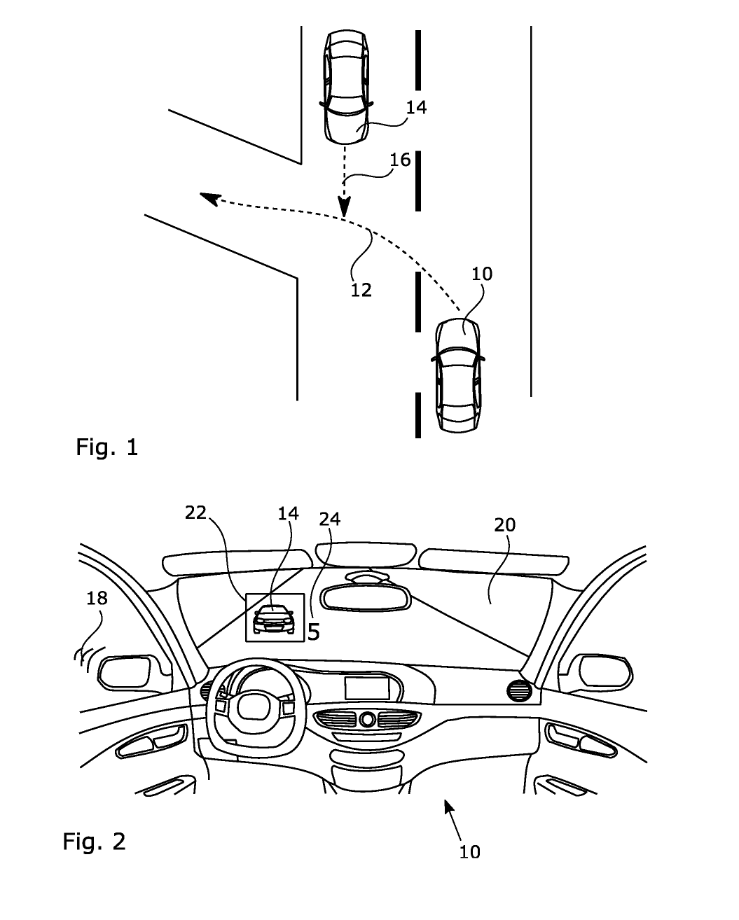

In order to guarantee a safe turning maneuver of a motor vehicle 10 in a traffic situation shown in FIG. 1, a driver assistance system of the motor vehicle 10 may detects the vehicle's own position, speed and acceleration in accordance with a method. The driver assistance system may compile an estimation regarding a future trajectory 12 of the motor vehicle 10. In the example illustrated in FIG. 1, a turn to the left is shown but the following description in not limited thereto. Likewise, the position, speed and, if applicable, the acceleration of further road users may be detected where only one further road user 14 is shown in FIG. 1. In each case, assigned future trajectories 16 may be established in order to determine a display relating to the safety of the traffic situation.

While the further road user 14 is represented as a motor vehicle in FIG. 1, it may also be a pedestrian, cyclist or the like. The same applies to FIG. 2, which shows an inner front view of the motor vehicle 10 from FIG. 1.

In order to establish the future trajectories 16 of the further road user 14, the same can be detected, for example, by a camera or by radar or lidar sensors. The indicated information can be exchanged via communication systems between the motor vehicle 10 and the road user 14. The indicated information may be measured and/or transmitted continually so that the trajectories 12, 16 are constantly updated.

In this example, the driver assistance system further checks whether the driver of the motor vehicle 10 is indicating a desire to turn. This can be established, for example, on the basis of activating an indicator signal 18. It is also possible that the driver assistance system monitors whether the motor vehicle 10 is turning into a turning lane. This can take place based on a front camera image or the combination of the geographical position of the motor vehicle and stored map data.

If a desire to turn is identified, the driver assistance system may check whether it is possible to turn safely based on the trajectories 12, 16. This information may be displayed to the driver of the motor vehicle 10 on a windscreen 20. This can take place, for example, by means of a head-up display. It is also possible to use transparent LED, LCD or OLED displays integrated into the windscreen 20; likewise, the information can be displayed on data goggles of the driver of the motor vehicle 10.

In this example, in order to inform the driver about the safety of the turning maneuver, a frame 22 is inserted around the further road user 14. The shown geometry of the frame 22 is, in this case, is only an example. The geometry is not limited to that illustrated and may include, for example, a bracket, a circle or the like. The coloring of the frame 22 may indicate the safety of the turning maneuver. For example, the color of the frame 22 can be green if it is possible to turn without any problems. However, if the turning maneuver is not possible, the color of the frame 22 may be red.

In addition to the frame 22, a time indication 24 may also be inserted which informs the driver about the time frame during which it is possible to turn safely. In this example, a numerical representation can serve as a countdown. In another example, another representation may also be selected. For example, a progress bar which shortens as the time reduces is possible. The time indication 24 can also be color coded like the frame 22 in order to send information which is easy to detect to the driver.

According to aspects and examples of the application, a driver assistance system is provided which assists a driver of a motor vehicle 10 during the decision-making process regarding a turning maneuver, and thus helps to avoid collisions in situations which may be particularly prone to accidents.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

### LIST OF REFERENCE NUMERALS

10 Motor vehicle
12 Trajectory
14 Road user
16 Trajectory
18 Indicator signal
20 Windscreen
22 Frame
24 Time indication

What is claimed is:

1. A method for assisting a driver of a motor vehicle during a turning maneuver, comprising:
detecting a driver's intention to make a turning maneuver;
detecting at least one other road user and determining at least a speed of the at least one other road user;
determining whether it is possible to make the turning maneuver safely as a function of at least the determined speed; and
displaying safety information related to the turning maneuver which is superimposed in the driver's direct view of the at least one other traffic user,
wherein the displayed safety information comprises an indication related to a time frame during which the turning maneuver is determined to be safe, the time frame is displayed by a countdown, and a numerical representation serves as the countdown.

2. The method according to claim 1, wherein the time frame is displayed by a progress bar.

3. The method according to claim 1, wherein the safety information of the turning maneuver comprises optical highlighting by means of at least one of a frame and color coding.

4. The method according to claim 1, wherein the at least one other road user and at least one of the speed and an acceleration thereof is detected using at least one of a vehicle-to-vehicle communication device and a sensor device comprising at least one of a front view camera, a radar sensor and a laser.

5. The method according to claim 1, further comprising detecting the intention to make a turning maneuver by detecting at least one of
an operation of an indicator,
driving into a turning lane, using position information of the motor vehicle or a signal of a front view camera,
a braking maneuver, and
a steering wheel angle.

6. The method according to claim 1, further comprising detecting at least one further variable which is characteristic of the traffic situation, and taking into consideration the at least one further variable during the determination of the display by displaying additional information.

7. The method according to claim 6, wherein the further variable is determined as a function of at least one of traffic signs, rights of way, street alignments, and weather conditions.

8. The method according to claim 6, wherein the additional information is only displayed if it is determined that the at least one other road user has a right of way.

9. A driver assistance system for a motor vehicle, comprising a unit which is configured to execute steps of a method according to claim 1.

10. A motor vehicle comprising a driver assistance system according to claim 9.

11. The motor vehicle according to claim 10, wherein the information is at least one of displayed in a region of a windscreen and displayed via a head-up display.
